(19) United States
(12) Patent Application Publication
(10) Pub. No.: US 2003/0196455 A1
(43) Pub. Date: Oct. 23, 2003

(54) Apparatus and method for photonic waveguide fabrication

(76) Inventors: Michael A. McCov, Burnsville, MN (US); James W. Zimmermann, Anoka, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/125,068

(22) Filed: Apr. 17, 2002

(51) Int. Cl. C03B 37/022; C03C 15/00

(52) U.S. Cl. 65/30.13; 65/386

(57) ABSTRACT

A photonic fabrication apparatus for making a waveguide in a glass substrate having a metal mask defining a region for the waveguide. The apparatus includes a molten salt, and a sacrificial anodic reaction material, in contact with the salt, that reacts with one or more contaminants in the salt. Also described is a salt-melt ion-exchange system having a chemical secondary reaction in the salt melt to prevent or reduce any primary reaction at or near the waveguide that would otherwise roughen sides of the waveguide and/or the surface over the waveguide.

### RELATED APPLICATIONS

This application is also related to: U.S. patent application Ser. No. 09/996,407, docket number 1014.018us1, entitled COMPACT APPARATUS AND METHOD FOR INTEGRATED PHOTONIC DEVICES HAVING FOLDED DIRECTIONAL COUPLERS filed on Mar. 29, 2002, and

U.S. patent application Ser. No. 09/996,407, docket number 1014.020us1, entitled METHOD AND APPARATUS FOR TAPPING A WAVEGUIDE ON A SUBSTRATE filed on Mar. 29, 2002, and

U.S. patent application Ser. No. 09/996,407, docket number 1014.01us1, entitled APPARATUS AND METHOD FOR INTEGRATED PHOTONIC DEVICES HAVING HIGH-PERFORMANCE WAVEGUIDES AND MULTICOMPOSITIONAL SUBSTRATES filed Nov. 27, 2001, and

U.S. patent application Ser. No. 09/996,346, docket number 1014.010us2, entitled APPARATUS AND METHOD FOR INTEGRATED PHOTONIC DEVICES HAVING GAIN AND WAVELENGTH-SELECTIVITY filed Nov. 27, 2001, and

U.S. patent application Ser. No. 09/996,404, docket number 1014.010us3, entitled APPARATUS AND METHOD FOR INTEGRATED PHOTONIC DEVICES HAVING ADD/DROP PORTS AND GAIN filed Nov. 27, 2001, and

U.S. patent application Ser. No. 09/996,406, docket number 1014.010us4, entitled APPARATUS AND METHOD FOR INTEGRATED PHOTONIC DEVICES HAVING ADJUSTABLE GAIN filed on even date herewith, and

U.S. patent application Ser. No. 09/490,748, docket number 1014.002us1, entitled RARE-EARTH DOPED PHOSPHATE-GLASS LASERS AND ASSOCIATED METHODS filed on Jan. 25, 2000, and

U.S. patent application Ser. No. 09/490,733, docket number 1014.004us1, entitled METHOD AND APPARATUS FOR CLOSED-CRUCIBLE PROCESSING OF WAVEGUIDE OPTICS filed on Jan. 25, 2000, and

U.S. patent application Ser. No. 09/490,730, docket number 1014.006us1, entitled METHOD AND APPARATUS FOR WAVEGUIDE OPTICS AND DEVICES filed on Jan. 25, 2000, each of which are incorporated in their entirety by reference.

### FIELD OF THE INVENTION

This invention relates to the field of optics and waveguides, and more specifically to a method and apparatus for forming an improved waveguide on a substrate.

### BACKGROUND OF THE INVENTION

Interest in the use of ion-exchanged glass waveguides for passive and/or active integrated optics has increased considerably recently. Typical examples of such devices include lasers, filters, modulators, power dividers and wavelength-selective directional or evanescent couplers. Waveguides are formed on a slab or substrate of glass as localized linear regions of a higher index of refraction. Waveguides contain a propagating light wave by total internal reflection. An optical glass waveguide is difficult to adjust after production; accurate control of production parameters is needed to obtain the desired waveguide reproducibility. To produce waveguides on or in an optical glass substrate, an ion-exchange technique is often employed. In these processes, waveguides are formed by the exchange of the original ions in the glass (typically sodium ions, Na+, in a phosphate-based glass) with ions increasing the refractive index (such as K+ or Ag+ ions) through a narrow opening in an ion-exchange mask applied to the substrate, and by using salt melts or a metal electrode as an ion source.

There is a need in the art for an improved waveguide fabrication system. The system should be highly reproducible, accurate, and stable.

### SUMMARY OF THE INVENTION

The present invention is salt-melt ion-exchange system having a chemical stabilizing reaction to prevent or reduce any reaction that would otherwise roughen sides of the waveguide and/or the surface over the waveguide.

In some embodiments, the present invention provides a salt melt for diffusing waveguide channels into a glass substrate, the salt melt including a source of ions having a standard electric potential difference to a component in the salt melt. In some embodiments, the glass substrate is, for example, a phosphate glass having an alkali, and the salt melt for the ion exchange includes molten AgNO3 as a source of silver ions. The salt melt further includes a source of metal for a sacrificial anodic reaction. In some embodiments, for example, a galvanized steel washer provides a source of zinc. The anodic reaction results reduced corrosion of the mask and in improved waveguides having smoother edges and/or a smoother surface over the waveguides that are formed.

One aspect of the present invention provides an apparatus for making a waveguide in a glass substrate, the glass substrate having a metal mask defining a region for the waveguide. The apparatus includes a molten salt, and a reaction material, in contact with the salt, that reacts with one or more contaminants in the salt.

The present invention also provides an apparatus for making a waveguide in a glass substrate, the glass substrate having a metal mask defining a region for the waveguide. This apparatus includes a molten salt and a reaction material in contact with the salt, wherein the reaction material catalyzes a reaction with one or more contaminants in the salt.

The present invention also provides a method for forming a waveguide, defined by a metal mask, into a glass substrate. The method includes melting an ion-exchange salt, reacting an anodic material with one or more dissolved contaminants in the melted salt, that creates a solid, and diffusing ions from the ion-exchange salt into the glass substrate.

In some embodiments, the glass substrate includes an aluminum mask, and dissolved water forms at least a portion of the contaminants. In some embodiments, the anodic material includes aluminum. In some embodiments, the anodic material includes Mn. In some embodiments, the anodic material includes Zn. In some embodiments, the anodic material includes Cr. In some embodiments, the anodic material includes Fe. In some embodiments, the anodic material includes Co. In some embodiments, the anodic material includes Ni. In some embodiments, the anodic material includes combinations of two or more metals selected from the group of aluminum, Mn, Zn, Cr, Fe, Co, and Ni (such as Zn and Fe).

The present invention also provides a method that includes melting an ion-exchange salt, reacting an anodic material with one or more dissolved contaminants in the melted salt, that creates a solid, and diffusing ions from the ion-exchange salt into a glass substrate. In some of these embodiments, but for reacting the anodic material, the glass substrate otherwise reacts with at least one of the contaminants. In some embodiments, but for reacting the anodic material, the glass substrate otherwise devitrifies due to at least one of the contaminants. In some embodiments, a surface of the glass substrate, but for reacting the anodic material, otherwise becomes roughened due to at least one of the contaminants.

The present invention also provides a method that includes melting an ion-exchange salt, catalyzing a reaction that includes one or more dissolved contaminants in the melted salt, and diffusing ions from the ion-exchange salt into a glass substrate. In some of these embodiments, but for catalyzing the anodic material, the glass substrate otherwise reacts with at least one of the contaminants. In some embodiments, but for catalyzing the anodic material, the glass substrate otherwise devitrifies due to at least one of the contaminants. In some embodiments, a surface of the glass substrate, but for catalyzing the anodic material, otherwise becomes roughened due to at least one of the contaminants.

### BRIEF DESCRIPTION OF THE DRAWINGS

FIG. 1 shows a diagrammatic cutaway perspective view of a waveguide fabrication apparatus 100 having an anticorrosion source 150.

FIG. 2 shows a diagrammatic cutaway perspective view of a waveguide fabrication apparatus 200 having an anticorrosion source 150.

FIG. 3 shows a schematic representation of a chemical process 300 having an anticorrosion source 150.

FIG. 4 shows a schematic representation of a manufacturing system 400 having an anticorrosion source 150.

### DESCRIPTION OF PREFERRED EMBODIMENTS

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention.

The present invention provides a process for forming waveguides onto (or into) the surface of a glass substrate. In one embodiment, photolithographic techniques define waveguides by changing the index of refraction of waveguide channels formed into the surface of the substrate. In one such embodiment, a glass wafer, for example approximately 10 cm by 10 cm by 1 mm, is cut from a slab of IOG-1 laser glass available from Schott Glass Technologies, Inc., of Duryea, Pa., USA. The surfaces of interest, including a major surface that is used for forming at least some of the waveguides, are polished to optical smoothness.

In some embodiments, a phosphate glass composition called IOG1 glass available from Schott Glass Technologies, Inc. is used, and molten silver- or potassium-salt ion exchange is used to form the waveguides. In some such embodiments, these waveguides are formed as described in the above mentioned U.S. patent application Ser. No. 09/490,730. In other embodiments, a silver salt ion exchange is used instead to form the waveguides, in order to make smaller-diameter waveguides. In some embodiments, for example, the doped glass is IOG1 glass that has an Erbium concentration of about 1.5 times 10²⁰ ions/cc and a Ytterbium concentration of about 6 to 8 times 10²⁰ ions/cc, and the undoped glass is IOG1 glass that has little or no Erbium or Ytterbium. In various other embodiments, the dopant combinations are Erbium about 1 times 10²⁰ ions/cc and Ytterbium about 4 times 10²⁰ ions/cc, Erbium about 1.5 times 10²⁰ ions/cc and Ytterbium about 4 times 10²⁰ ions/cc, Erbium about 1 times 10²⁰ ions/cc and Ytterbium about 6 times 10²⁰ ions/cc, Erbium about 1.25 times 10²⁰ ions/cc and Ytterbium about 6 times 10²⁰ ions/cc, or Erbium about 1.5 times 10²⁰ ions/cc and Ytterbium about 6 times 10²⁰ ions/cc. In some embodiments, shorter devices include doping with a higher a Ytterbium concentration, in order to have the pump light absorbed within the device rather than exiting the device as waste light.

One problem that has been identified is non-smooth sides along the length of the waveguides, thought to be caused by a chemical reaction during the salt-melt process. Retaining defect-free waveguide sides having little or no side or surface roughness and retaining surface flatness of the glass article is important for slab waveguide applications, because one major cause of the intensity attenuation of a light wave traveling through a waveguide that is transparent to the wavelength of the propagating light is waveguide scattering. When waveguides are formed in a salt melt, a mask is used of metal that does not melt at the temperature of the salt melt. The waveguide formation of the present invention is performed in an environment that excludes water, such as humidity from the air, from entering the processing area. In addition, the present invention provides a sacrificial anodic reaction that removes water that has entered the melt.

Another problem can be rugosity on the surface of the waveguides, thought to be caused, in some embodiments, at least in part by a chemical reaction during the salt-melt waveguide-diffusion processes. Retaining a defect-free surface having little or no surface roughness and of retaining surface flatness of the glass article is important for slab waveguide applications, because one major cause of the intensity attenuation of a light wave traveling through a waveguide that is transparent to the wavelength of the propagating light is surface scattering.

One aspect of the present invention provides a salt melt for diffusing waveguide channels into a glass substrate, the salt melt including a source of ions having a standard electric potential that is different than that of a component in the salt melt (for example, as compared to a metal used for the mask). In some embodiments, the glass substrate is, for example, a phosphate glass having an alkali component (such as IOG8 glass available from Schott Glass Technology, Inc) and having a mask that includes aluminum, and the salt melt for the ion exchange including molten AgNO3 as a source of silver ions. The salt melt further includes a source of atoms, such as metal atoms, for an anodic reaction. In some embodiments, for example, a galvanized steel washer provides a source of zinc. The anodic reaction results in improved waveguides having less loss due to smoother edges and/or a smoother surface over the waveguides that are formed.

In some embodiments, unwanted residual water is believed to detrimentally affect the surface of the phosphate glass substrate and/or to corrode the aluminum mask (such as the edges of the mask along openings that define the waveguide(s), particularly under elevated temperatures. Therefore, care is taken to eliminate as much of the water as possible by such means as pre-baking the substrate to drive water out, and containing the salt-melt process, during the heat-up, diffusion and cool-down phases, within a gas source that does not contain water. In some embodiments, extra care is also taken (1) to fabricate the glass substrate itself in an environment that excludes, or reduces exposure to, water, and/or (2) to ship the glass substrates in a container that excludes water. In some embodiments, a dry gas such as purified helium, argon, oxygen and/or nitrogen is used in the volume around the processing area or vessel, in order to exclude atmospheric water. In some embodiments, a vacuum or reduced pressure (i.e., a pressure much less than atmospheric pressure, along with a controlled amount of helium, argon, oxygen and/or nitrogen) is used to exclude atmospheric water. In other embodiments, a positive pressure of dry gas (e.g., helium, argon, oxygen and/or nitrogen) is used around the processing area or vessel, in order to exclude atmospheric water as well as to reduce the requirement to seal off the reaction sites that are needed in some embodiments of the other methods described earlier in this paragraph.

In some embodiments, it is believed that a combination of reactions takes place at the metal source that was added according to the present invention (for example, the zinc-steel washer used, in some embodiments, with the aluminum-masked phosphate-glass-substrate processing), videlicet:

(1) a displacement reaction similar to a “silver strike” reaction that is often encountered in electroplating operations, for example:

2Ag⁺+Zn(metal)=>Zn²⁺+2Ag(metal)

and

(2) a reaction with residual water in the melt and/or coming from glass substrate, for example:

2H₂O+Zn(solid)=>Zn(OH)₂(solid)+H₂(gas).

In some embodiments, extensive bubble formation has been observed, and it is believed that there is a gaseous product formed at the zinc surface. Further, when processing was complete, the aluminum mask on the glass substrate was observed to be very clean, and the zinc washer was observed to be quite corroded. The present invention, however, does not depend on a particular reaction or combination of reactions, rather the introduction of one or more alternative reactions (e.g., with one or more suitable metals) results in improved waveguide structures. In some embodiments, the introduction of sacrificial anodic atoms “getters” (i.e., removes) one or more contaminates (it is believed these contaminates include dissolved water) from the molten salt, and thus reduces chemical attack of the aluminum mask and/or glass surface. It is believed that alternatively or additionally, the reaction also prevents or reduces devitrification of the phosphate glass substrate. Such devitrification is catalyzed by residual moisture in the molten salt.

Source 150 is called herein an “anticorrosion source” since one or more reactions appear to be corrosion and/or devitrification. However, because one or more of the reactions are not completely understood, “anticorrosion source” as used herein shall mean something that prevents or reduces one or more deleterious reactions at or on the glass substrate or its mask materials.

Residual moisture can result from water in the source salt used for processing, in the glass substrate as it enters the melt, and/or atmospheric water.

A chemical attack of the mask during the salt melt that corrodes the surface of the mask, and particularly one that roughens the edges of the mask next to the waveguides, results in rough edges of the waveguide being diffused. Thus, reducing the corrosion of the mask leaves smoother the edges of the mask that define the waveguides, so that the waveguides themselves have straighter edges, which have less light loss.

In some embodiments, an aluminum mask is used. A chemical attack of the aluminum mask by, e.g., water, corrodes the surface of the aluminum, and particularly along the edges of the mask next to the waveguides, a rough mask results in rough edges of the waveguide defined by the mask that are being diffused. Thus, reducing the corrosion of the aluminum mask leaves smoother the edges of the mask that define the waveguides, so that the waveguides themselves have straighter edges, which have less light loss.

In other embodiments, one or more other metals besides or in addition to aluminum are used for the mask material.

In various embodiments, the sacrificial reaction includes one or more metals such as Mn, Zn, Cr, Fe, Co, and Ni in the sacrificial anode or anodes, and a mask material that has mostly or totally aluminum. In some embodiments, even aluminum is used as a sacrificial anode material, in order to compete with the aluminum mask for any species that would otherwise react with the mask aluminum. In some such embodiments, an aluminum sacrificial anode is used (additionally or alternatively) to pre-treat the molten salt in order to remove any contaminant that reacts with aluminum, before the aluminum-masked glass substrates are introduced into the salt melt.

In some embodiments, a sacrificial anode is used that contains a metal that melts at a temperature below that of the salt melt (for example, lead having a melting point of about 600 degrees K, tin at about 505K and/or indium at about 430K). Thus, in such embodiments, the “anode” is a liquid that sits in contact with the salt melt, or even is dissolved in the salt melt, but which has a chemical reaction with contaminants such as water to form a solid (or, in some embodiments, a relatively (compared to the glass or mask) inert liquid or gas product), thus protecting the glass and/or mask material from a deleterious reaction that would otherwise occur.

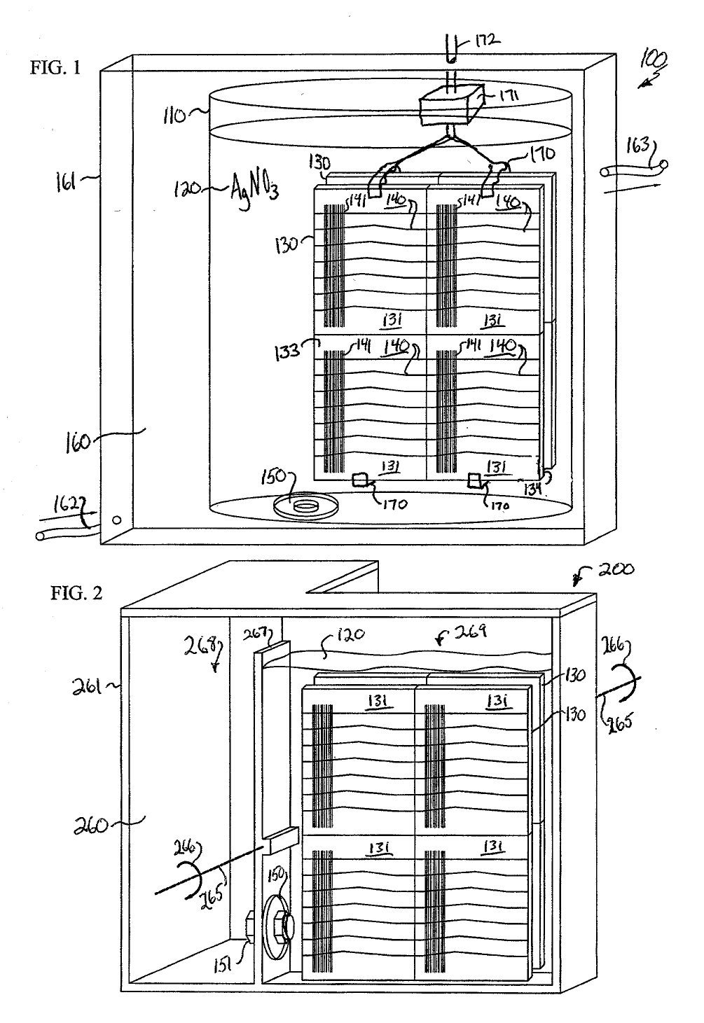

FIG. 1 shows a schematic cutaway perspective view of a waveguide fabrication apparatus 100 having an anticorrosion source 150. While the actual action, or mechanism of the action, of source 150 is not fully understood, it is thought to act as a sacrificial electrode that provides an alternative chemical reaction to stop or reduce one or more deleterious chemical reactions that otherwise occur at or near the surface of one or more waveguides that are being formed by ion diffusion in the salt melt. It is thought that otherwise oxygen and/or water react with one or more components of the phosphate glass at the surface. In some embodiments, source 150 includes zinc, a zinc compound, or a zinc alloy. For example, in some embodiments, source 150 includes one or more common galvanized washers, as are commonly available at any hardware store. In some embodiments, these are one or more common washers washed and cleaned to remove oil or other contaminants, and placed in the salt melt. In some embodiments, the combination of metals such as iron, carbon, or other components in such steel washers provides results that are superior to those obtained using a purified zinc source alone.

In some embodiments, it is believed that, in some embodiments, at least some water is in the substrates due to the glass processing of melting the source glass, forming a piece of glass, slicing that into thin glass substrate, and transporting the substrates to the facility that performs the waveguide formation. It is believed that, in some embodiments, this water moves out of the substrate at temperatures of the salt melt, and that by providing the sacrificial anodic reaction, degrading effects of reactions of this water are reduced.

FIG. 1 is not to scale. In some embodiments, a substrate holder 170, optionally having a weight 171 suspended from rod 172, is used to lower and raise the substrates into and from the salt bath 120 in container 110. In some embodiments, the substrates 130 each include one or more waveguides 140 and/or one or more gratings 141, which are formed or processed by the diffusion of ions from the salt bath 120. In some embodiments, the substrates 130 are held vertically as shown. In other embodiments, the substrates are held horizontally (as shown in FIG. 4), in order that all waveguides meet and leave the salt melt at substantially the same time, so all diffusion processes have the same duration. This is important where the immersion is slow and the process duration is short.

In some embodiments, salt melt 120 is a eutectic mix of sodium nitrate and potassium nitrate, used to bury a silver-ion-based waveguide structure into the glass.

In some embodiments, each substrate 130 has an obverse side 133 (onto and/or into which the photonics structures are built) and a reverse side 134, and includes a plurality of photonics chips 131 that are later diced from the completed glass substrate wafer 130. In some embodiments, a plurality of different respective waveguides 140 interacts with one or more gratings 141 at a plurality of different respective angles.

In some embodiments, the reaction of FIG. 1 is contained within an envelope 161, optionally having gas input port 162 that supplies gas 160, and gas output port 163, which together help to keep contaminants from the diffusion process, also acting to reduce contamination by substances such as water.

FIG. 2 shows a diagrammatic cutaway perspective view of a waveguide fabrication apparatus 200 having an anticorrosion source 150. Apparatus 200 includes a closed crucible container 261 having a removable lid, and having two compartments 268 and 269 separated by divider 267. Crucible 261 rotates 266 about axis 265, in order to move the molten salt 120 from one to the other compartment. This allows the substrate(s) 130 to be held in place in compartment 269, while the liquid salt is moved. Moving the salt in such a crucible allows the process to be carefully timed, to control the size and/or depth of the waveguides. System 200 includes a nut and bolt 151 to hold in place anticorrosion source 150 (e.g., a zinc galvanized washer 150 (or merely the zinc galvanized nut and bolt themselves acting as such a sacrificial anode) placed in one or both compartments 268 and 269). In other embodiments, one or more separate anticorrosion sources 150 are placed in one or the other or both of compartments 268 and 269. Not shown are items well known in the art such as heat sources, pumps, fans, stirrers, etc. which, in some embodiments, are also used in systems 100 and 200 to heat and/or mix the salt melt during processing to maintain an even and homogenous ion-exchange medium, and/or heat and/or mix the atmosphere gas 160.

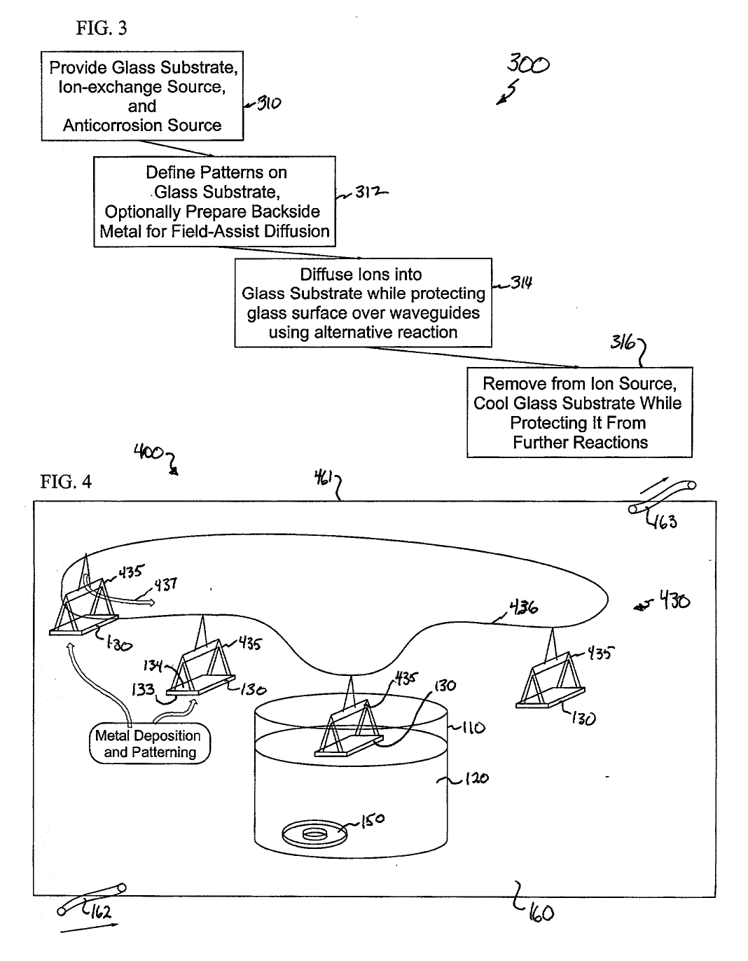

FIG. 3 shows a schematic representation of a chemical process 300 having an anticorrosion source 150. FIG. 4 shows a schematic representation of a manufacturing system 400 used in some embodiments of process 300. Process 300 includes a plurality of subprocesses, some of which are combined, modified, or omitted in some embodiments. Subprocess 310 includes obtaining one or more glass substrates 130, and providing an ion-exchange source 120 and anticorrosion source 150. Subprocess 312 includes, in some embodiments, defining patterns for waveguides, gratings, splitters, couplers, etc. onto one or more surfaces of substrate 130, and, in some embodiments, also includes depositing a backside metalization onto reverse side 134, opposite the obverse side 133 onto which surface waveguides are, or are to be, formed. In some embodiments, obverse side 133 has an aluminum mask that has been removed only along the locations that waveguides are to be formed, in order that silver nitrate from a salt melt can provide silver ions diffused into subportions of the surface of side 133 to form the waveguides. In other embodiments, a silver film is sputtered onto surface 133, and removed from all areas except where the silver-ion waveguide is to be formed, and the substrate 130 is heated to diffuse silver ions from the silver lines into the substrate to form the waveguides. Subprocess 314, in some embodiments, uses a salt melt to diffuse ions forming the waveguides into substrate 130 through slits in the aluminum mask. In other embodiments, subprocess 314 is a subsequent process that buries previously deposited waveguide ions by ions such as sodium and/or potassium, for example.

Process 314 also includes using an anticorrosion process (such as anticorrosion source 150) to reduce or eliminate contaminants such as water from the salt melts that either deposits the waveguides and/or buries the waveguides.

In some embodiments, the silver ions thus deposited at or near the surface are driven into the substrate (buried) by using a subsequent field-assisted diffusion from a eutectic melt of sodium nitrate and potassium nitrate. In some such embodiments, a DC voltage is applied to the backside metalization and the salt melt, wherein obverse side 133 is facedown in melt 120 and reverse side 134 is not contacting the melt, but forms the electrical contact for the field assist. In some embodiments, the backside metalization is covered with an insulator such as silicon dioxide, in order that the entire glass substrate can be immersed for the field assist diffusion. Subprocess 316 removes the substrate from the melt, and optionally cools the substrate while protecting it from further reactions.

In some embodiments, a conveyor mechanism 430 is used to carry the substrates through one or more of the subprocesses. For example, a belt 436 carries substrate holders 435 (each carrying one or more substrates 130) through the various subprocesses. In some embodiments, the substrates are held with the major faces oriented horizontally for the salt-melt process.

In most cases, the sacrificial reaction takes place at the site of the sacrificial anode, for example, with water from the salt melt moving to the sacrificial anode and reacting there. In some embodiments, however, a very small amount of the sacrificial anode goes into the salt melt, and a trace amount of one or more elements of the sacrificial material (such as zinc) transfers to, and remains in or on the resulting glass substrate, for example, mostly in the area above the waveguides.

### CONCLUSION

One aspect of the present invention provides an apparatus 100, 200, 300 or 400 for making a waveguide 140 in a glass substrate 130, the glass substrate 140 having a metal mask defining a region for the waveguide. The apparatus includes a molten salt 120, and a reaction material 150, in contact with the salt, that reacts with one or more contaminants in the salt.

In some embodiments, a reaction between the material 150 and the one or more contaminants forms a solid in the molten salt 130.

Some embodiments further include an immersion mechanism 170 or 130 that introduces at least a portion of the glass substrate 130 into the molten salt 120.

In some embodiments, the mask includes aluminum, and the reaction material 150 includes zinc and iron. In some such embodiments, the reaction material 150 includes galvanized steel.

In some embodiments, the reaction material 150 reacts with dissolved water in the salt melt 120 to form a solid.

In some embodiments, the reaction material 150 reacts with dissolved water in the salt melt to form a solid during a time that the glass substrate is immersed in the molten salt.

In some embodiments, the reaction material reacts with dissolved water in the salt melt to form a solid before the glass substrate is put in contact with the molten salt.

In some embodiments, the reaction material reacts with dissolved water in the salt melt to form a precipitate.

The present invention also provides an apparatus for making a waveguide in a glass substrate, the glass substrate having a metal mask defining a region for the waveguide. This apparatus includes a molten salt and a reaction material in contact with the salt, wherein the reaction material catalyzes a reaction with one or more contaminants in the salt.

The present invention also provides a method for forming a waveguide, defined by a metal mask, into a glass substrate. The method includes melting an ion-exchange salt, reacting an anodic material with one or more dissolved contaminants in the melted salt, that creates a solid, and diffusing ions from the ion-exchange salt into the glass substrate.

In some embodiments, the melting, reacting, and diffusing are performed in the order shown.

Some embodiments further include masking the substrate 130 with a patterned metal mask that otherwise reacts with at least one of the contaminants. In some embodiments, the metal mask covers the areas of the substrate 150 that are not being diffused and does not cover the areas being diffused, e.g., the waveguides. In some embodiments, preventing reactions between the metal mask and contaminants in the salt melt 120 and/or the gas atmosphere 160 provides smoother edges to the waveguides and/or smoother surfaces over the waveguides.

In some embodiments, the reacting includes placing a sacrificial anodic material in contact with the salt. In some embodiments, the reacting includes placing a zinc and iron material in contact with the salt. In some such embodiments, the zinc and iron material includes galvanized steel.

Some embodiments further include immersing the glass substrate into the salt melt. In some such embodiments, the immersing takes place at a time after the reacting. Some embodiments further include only partially immersing the glass substrate into the salt melt.

In some embodiments, at least some of the reacting takes place after the immersing takes place.

In some embodiments, the melting of the salt takes place at a temperature below a melting point of the anodic material.

In some embodiments, the glass substrate includes an aluminum mask, and dissolved water forms at least a portion of the contaminants. In some embodiments, the anodic material includes aluminum. In some embodiments, the anodic material includes Mn. In some embodiments, the anodic material includes Zn. In some embodiments, the anodic material includes Cr. In some embodiments, the anodic material includes Fe. In some embodiments, the anodic material includes Co. In some embodiments, the anodic material includes Ni. In some embodiments, the anodic material includes combinations of two or more metals selected from the group of aluminum, Mn, Zn, Cr, Fe, Co, and Ni (such as Zn and Fe).

Some embodiments further include masking the glass substrate with a metal that otherwise reacts with at least one of the contaminants.

In some embodiments, the masking, melting, reacting, and diffusing are performed in the order: (1) masking, (2) melting, (3) reacting, and (4) diffusing, however the invention is not limited to this order and various of the steps listed are performed simultaneously in other embodiments, and some embodiments use a different order of processing.

In some embodiments, but for the anodic reaction, the glass substrate otherwise reacts with at least one of the contaminants. In some embodiments, but for the anodic reaction, the glass substrate otherwise devitrifies due to at least one of the contaminants. In some embodiments, but for the anodic reaction, a surface of the glass substrate otherwise becomes roughened due to at least one of the contaminants.

The present invention also provides a method that includes melting an ion-exchange salt, reacting an anodic material with one or more dissolved contaminants in the melted salt, that creates a solid, and diffusing ions from the ion-exchange salt into a glass substrate. In some of these embodiments, but for reacting the anodic material, the glass substrate otherwise reacts with at least one of the contaminants. In some embodiments, but for reacting the anodic material, the glass substrate otherwise devitrifies due to at least one of the contaminants. In some embodiments, a surface of the glass substrate, but for reacting the anodic material, otherwise becomes roughened due to at least one of the contaminants.

In some embodiments, the anodic material is a solid at the temperatures of the melted salt. In other embodiments, the anodic material is a liquid at the temperatures of the melted salt.

The present invention also provides a method that includes melting an ion-exchange salt, catalyzing a reaction that includes one or more dissolved contaminants in the melted salt, and diffusing ions from the ion-exchange salt into a glass substrate. In some of these embodiments, but for catalyzing the anodic material, the glass substrate otherwise reacts with at least one of the contaminants. In some embodiments, but for catalyzing the anodic material, the glass substrate otherwise devitrifies due to at least one of the contaminants. In some embodiments, a surface of the glass substrate, but for catalyzing the anodic material, otherwise becomes roughened due to at least one of the contaminants.

The present invention also provides an apparatus for processing a glass substrate having a metal mask. The apparatus includes a molten salt, a mechanism that introduces the glass substrate into the molten salt, and sacrificial anodic means having structure as described for FIGS. 1, 2, or 3 and 4, in contact with the molten salt for improving a quality of a waveguide defined by the metal mask and formed in the glass substrate. In some embodiments, the quality that is improved is waveguide smoothness. In some embodiments, the quality that is improved is the amount of loss of waveguide.

The present invention also provides an apparatus for processing a waveguide in a glass substrate, wherein a first reaction would degrade an optical performance characteristic of the waveguide. This apparatus includes a molten salt, a mechanism that introduces the glass substrate into the molten salt, and a second chemical reaction in the molten salt for improving the optical performance characteristic of a waveguide formed in the glass substrate.

The present invention also provides combinations of any two or more of the above features.

It is understood that the above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. An apparatus for making a waveguide in a glass substrate, the glass substrate having a metal mask defining a region for the waveguide, the apparatus comprising:
a molten salt; and
a reaction material, in contact with the salt, that reacts with one or more contaminants in the salt.

2. The apparatus of claim 1, wherein a reaction between the material and the one or more contaminants forms a solid in the molten salt.

3. The apparatus of claim 1, further comprising:
an immersion mechanism that introduces the glass substrate into the molten salt.

4. The apparatus of claim 1, wherein the mask includes aluminum, and the reaction material includes zinc and iron.

5. The apparatus of claim 4, wherein the reaction material includes galvanized steel.

6. The apparatus of claim 5, wherein the reaction material reacts with dissolved water in the salt melt to form a solid.

7. The apparatus of claim 5, wherein the reaction material reacts with dissolved water in the salt melt to form a solid while the glass substrate is immersed in the molten salt.

8. The apparatus of claim 1, wherein the reaction material reacts with dissolved water in the salt melt to form a solid before the glass substrate is put in contact with the molten salt.

9. The apparatus of claim 1, wherein the reaction material reacts with dissolved water in the salt melt to form a precipitate.

10. An apparatus for making a waveguide in a glass substrate, the glass substrate having a metal mask defining a region for the waveguide, the apparatus comprising:
a molten salt; and
a reaction material, in contact with the salt, that catalyzes a reaction with one or more contaminants in the salt.

11. A method for forming a waveguide, defined by a metal mask, into a glass substrate, the method comprising:
melting an ion-exchange salt;
reacting an anodic material with one or more dissolved contaminants in the melted salt, that creates a solid; and
diffusing ions from the ion-exchange salt into the glass substrate.

12. The method of claim 11, wherein the reacting include placing a sacrificial anodic material in contact with the salt.

13. The method of claim 11, wherein the reacting include placing a zinc and iron material in contact with the salt.

14. The method of claim 13, wherein the zinc and iron material includes galvanized steel.

15. The method of claim 11, further comprising immersing the glass substrate into the salt melt.

16. The method of claim 15, wherein the immersing takes place after the reacting.

17. The method of claim 15, wherein at least some of the reacting takes place after the immersing takes place.

18. The method of claim 11, wherein the melting of the salt takes place at a temperature below a melting point of the anodic material.

19. The method of claim 11, wherein the glass substrate includes an aluminum mask, wherein dissolved water forms at least a portion of the contaminants, and wherein the anodic material includes one or more metals selected from the group of aluminum, Mn, Zn, Cr, Fe, Co, and Ni.

20. The method of claim 11, further comprising masking the glass substrate with a metal that otherwise reacts with at least one of the contaminants.

21. The method of claim 20, wherein the masking, melting, reacting, and diffusing are performed in the order shown in this claim.

22. The method of claim 11, wherein the glass substrate otherwise reacts with at least one of the contaminants.

23. The method of claim 11, wherein the glass substrate otherwise devitrifies due to at least one of the contaminants.

24. The method of claim 11, wherein a surface of the glass substrate otherwise becomes roughened due to at least one of the contaminants.

25. A method comprising:
melting an ion-exchange salt;
reacting an anodic material with one or more dissolved contaminants in the melted salt, that creates a solid; and
diffusing ions from the ion-exchange salt into a glass substrate.

26. The method of claim 25, wherein the glass substrate otherwise reacts with at least one of the contaminants.

27. The method of claim 25, wherein the glass substrate otherwise devitrifies due to at least one of the contaminants.

28. The method of claim 25, wherein a surface of the glass substrate otherwise becomes roughened due to at least one of the contaminants.

29. The method of claim 25, further comprising only partially immersing the glass substrate into the salt melt.

30. The method of claim 29, further comprising applying an electric field across the glass substrate from one major face to another major face.

31. A method comprising:
melting an ion-exchange salt;
catalyzing a reaction that includes one or more dissolved contaminants in the melted salt; and
diffusing ions from the ion-exchange salt into a glass substrate.

32. The method of claim 31, wherein the glass substrate otherwise reacts with at least one of the contaminants.

33. The method of claim 31, wherein the glass substrate otherwise devitrifies due to at least one of the contaminants.

34. The method of claim 31, wherein a surface of the glass substrate otherwise becomes roughened due to at least one of the contaminants.

35. An apparatus for processing a glass substrate having a metal mask, the apparatus comprising:
a molten salt;
a mechanism that introduces the glass substrate into the molten salt; and
sacrificial anodic means in the molten salt for improving a quality of a waveguide defined by the metal mask and formed in the glass substrate.

36. The apparatus of claim 35, wherein the quality that is improved is waveguide smoothness.

37. The apparatus of claim 35, wherein the quality that is improved is the amount of loss of waveguide.

38. An apparatus for processing a waveguide in a glass substrate, wherein a first reaction would degrade an optical performance characteristic of the waveguide, the apparatus comprising:
a molten salt;
a mechanism that introduces the glass substrate into the molten salt; and
a second chemical reaction in the molten salt for improving the optical performance characteristic of a waveguide formed in the glass substrate.
